(19) United States
(12) Patent Application Publication
(10) Pub. No.: US 2020/0193373 A1
(43) Pub. Date: Jun. 18, 2020

(54) PARCEL DELIVERY SYSTEM AND PARCEL DELIVERY ASSEMBLY

(71) Applicant: ARAD ART DISPLAY LTD., Kfar Saba (IL)

(72) Inventor: Raziel VARMAN, Modi'in (IL)

(21) Appl. No.: 16/500,477

(22) PCT Filed: Apr. 8, 2018
(86) PCT No.: PCT/IL2018/050405

§ 371 Date: Oct. 3, 2019

(30) Foreign Application Priority Data
Apr. 3, 2017 (IL) 251528

(51) Int. Cl. G06Q 10/08; A47G 29/122; A47G 29/124; G07F 17/12

(52) U.S. Cl. CPC G06Q 10/0836; A47G 29/1225; G06Q 50/28; G07F 17/12; A47G 29/124

(57) ABSTRACT

A parcel delivery system which includes: a processing system including at least one processor and a communications subsystem; an array of parcel boxes, each including: an enclosure having a front opening; a door; an electrically controlled lock mechanism switchable in response to a signal from the processing system; an enclosure occupancy sensor configured to sense whether or not the enclosure contains a parcel; the processing system is configured to: allocate to the parcel one of the boxes determined to be empty based on an output of the occupancy sensor; determine when the parcel has been placed in the allocated box; send to a mobile electronic device of the recipient a notification indicative of the allocated box; and, on receipt of an unlock request received from the mobile electronic device of the recipient, to actuate the lock mechanism to switch from a locked state to an unlocked state.

### FIELD OF THE INVENTION

The field of invention relates in general to systems for delivering parcels to recipients. More specifically, the invention relates to a distributed system for delivering parcels, and to a parcel delivery assembly.

### BACKGROUND OF THE INVENTION

The development of e-marketing in the recent years has significantly increased the quantity and volume of parcels that are delivered world-wide by government posts or by private parcel delivery companies (hereinafter, both organizations will be referred to herein as “parcel delivery organizations”). The amount of parcel deliveries continues to significantly grow annually. The quantity of standard-envelope mail deliveries, on the other hand, significantly decreases annually, in view of sending most of the printed documents by e-mail, or by other internet-related communication means. Even in view of these developments, many parcel delivery organizations still request the parcel recipients to arrive at the post (or similar) office during the regular opening hours to collect their parcels. A vast majority of rented post office boxes that have been designed for standard-envelope mail, cannot assist the parcel recipients, as many of the parcels that are delivered today have a volume which is larger than the volume of the standard rented post office box.

The above developments have required the parcel delivery organizations to differently organize in terms of fast and efficient parcel processing and delivery, and in manners that are also more convenient to the parcel recipients. Various solutions that are more convenient to the recipients have been developed in the recent years. For example, parcel delivery organizations have begun to mount neighbourhood-type parcel collection assemblies. Throughout this application, the terms “parcel collection assembly” and “parcel delivery assembly” are used interchangeably. Such neighbourhood parcel collection assemblies are typically positioned indoor or outdoor, within, or in proximity of stores, gas stations, or commercial areas, etc., and include an array of boxes (compartments), sometimes with a variety of different-volume boxes. When a parcel is inserted into a compartment by a postman, the compartment door is locked, and the delivery organization sends a message to the recipient (typically to his mobile phone), which is associated with a compartment-identification (that identifies the specific compartment), and a code for unlocking and opening the respective compartment. The use of such neighbourhood-type parcel assemblies, particularly when positioned outdoor, extends the parcel collection hours, sometimes up to 24 hours a day, 365 days a year.

The prior art provides two alternative solutions at the box assembly for enabling the recipient to unlock and open the respective compartment. A first, “distributed” approach, provides a keypad on each compartment door, such that typing the correct code on the keypad unlocks the door. A second, “central” approach provides a single, central touch (or similar) screen which serves the entire boxes of the assembly. When the user approaches the touch screen, he first types the compartment ID, and then the opening code that he previously received to his mobile phone. The typing of the correct code on the central touch screen unlocks the door of the respective compartment, such that the recipient can open the door and collect his item. Both of the above approaches suffer from significant drawbacks. The first approach is cumbersome and expensive, as it requires mounting of a keypad and some associated opening electronics in each compartment. The second approach is also expensive, as it requires the provision of a touch screen (or similar) which is prone to environmental damages, such as rain, heat, etc., therefore various additional means have to be provided at the assembly to protect the touch screen. Moreover, the touch screen itself comes in the expense of a space that may otherwise be dedicated to additional one or more parcel boxes. Furthermore, the “central” (touch screen) approach, in similarity to the case of an ATM, can serve one recipient at any given time, and does not enable a simultaneous retrieval of parcels from plurality of boxes.

In another aspect, it is of course desired to place neighbourhood-type box assemblies in various locations that are convenient to both the recipients and the parcel servicing staff (hereinafter “postman”). Some of these locations require the existence of parking areas nearby. This requirement somewhat excludes central and dense locations where parking spaces are limited. Moreover, the neighbourhood-type box assembly requires a provision of electric power. This requirement excludes even additional locations for placement of box assemblies, such as junctions in rural areas, sidewalks, etc., where car parking spaces are more available, but a supply of electric power is somewhat problematic or requires special installations and arrangements. Both the “distributed” and “central” prior art solutions, however, typically consume a relatively high power, or at least they are not designed for low power consumption, which has to be continuously supplied from the main electricity network.

In still another aspect, the increased number of parcels delivery significantly increases the load and the responsibility which is imposed on the postman. For example, in assemblies having a single large (front or rear) door which opens to allow a simultaneous access for the postman to a plurality (sometimes many) compartments, there is a significant risk for errors by the postman, who may insert a parcel to a wrong compartment. Of course, any of such errors is intolerable. It is therefor desired to provide a system for automatically checking, detecting, and alerting immediately upon occurrence of such errors.

### BRIEF DESCRIPTION OF THE DRAWINGS

FIG. 1 illustrates in a block diagram form the general structure of the parcel delivery system according to an embodiment of the present invention;

FIG. 2a shows in a schematic general form an exemplary neighbourhood-type parcel delivery assembly according to an embodiment of the present invention;

FIG. 2b shows in a schematic general form a 3-compartments module of the exemplary neighbourhood-type parcel delivery assembly according to an embodiment of the present invention;

FIGS. 3a-3e generally illustrate the internal structure of each compartment of the parcel delivery assembly, according to an embodiment of the invention;

FIG. 4 describes in a block diagram form how the assembly processor controls and monitors the operation of each compartment, according to an embodiment of the invention;

FIG. 5 shows an exemplary circuit for the assembly processor according to an embodiment of the invention;

FIG. 6 describes a procedure which is performed by a postman, according to an embodiment of the present invention;

FIG. 7 illustrates in a block diagram form the procedure which is carried out by the recipient in order to collect his item from the parcel delivery assembly, according to an embodiment of the present invention.

### SUMMARY OF THE INVENTION

The invention relates to a parcel delivery system for allowing recipients to retrieve parcels by use of a mobile electronic device of the recipient, the system includes: (a) a processing system including at least one processor and a communications subsystem; (b) an array of parcel boxes, each parcel box including: (b.1) an enclosure having a front opening; (b.2) a door displaceable between a closed state, obstructing the front opening, and an open state, allowing access via the front opening to the enclosure; (b.3) an electrically controlled lock mechanism configured to be switchable in response to a signal from the processing system from a locked state in which the lock mechanism prevents displacement of the door from the closed state to the open state to an unlocked state in which a recipient can displace the door from the closed state to the open state; (b.4) an enclosure occupancy sensor in communication with the processing system and configured to sense whether or not the enclosure contains a parcel; wherein the processing system is configured, for each parcel to be delivered, to: (i) allocate to the parcel one of the boxes determined to be empty based on an output of the occupancy sensor; (ii) determine when the parcel has been placed in the allocated box based at least in part on the output of the occupancy sensor; (iii) send to the mobile electronic device of the recipient a notification indicative of the allocated box; and (iv) on receipt of an unlock request received from the mobile electronic device of the recipient, to actuate the lock mechanism to switch from the locked state to the unlocked state, thereby allowing opening of the door by the recipient to retrieve the parcel.

In an embodiment of the invention, the system further includes a door opening sensor in communication with the processing system and deployed to sense whether the door is in the open state or in the closed state.

In an embodiment of the invention, the electrically controlled lock mechanism includes a bistable actuator, and wherein the processing system is further configured to be responsive to closing of the door as sensed by the door opening sensor to actuate the lock mechanism to switch from the unlocked state to the locked state.

In an embodiment of the invention, the processing system is further configured to be responsive to the occupancy sensor indicating that the parcel has been removed from the allocated box to designate the allocated box as an available box for allocation to a subsequent parcel.

In an embodiment of the invention, the parcel delivery system further includes a door biasing arrangement biasing the door to return from the open state to the closed state.

In an embodiment of the invention, the processing system is further configured to periodically retrieve an output from the occupancy sensor of each box and to compare a detected occupancy output with an expected occupancy output, the processing system generating an error signal if the detected occupancy output does not match the expected occupancy output.

In an embodiment of the invention, the processing system is configured to receive from a mobile electronic device of a mailman an indication of a parcel scanned prior to loading into an allocated box, the indication being used to update an expected occupancy setting for the allocated box.

In an embodiment of the invention, each parcel box further includes a lock status sensor associated with the processing system and configured to generate a signal indicative of whether the electrically controlled lock mechanism is in the locked state or the unlocked state.

In an embodiment of the invention, the processing system is responsive to signals from the lock status sensor and the door opening sensor to generate an error signal if the door remains in a state other than closed and locked for more than a defined period.

In an embodiment of the invention, the array or parcel boxes includes a plurality of parcel boxes, and wherein the enclosure of each of the parcel boxes includes at least four walls such that removal and replacement of one of the parcel boxes does not compromise the enclosure of neighboring parcel boxes.

In an embodiment of the invention, each of the parcel boxes carries a reconfigurable display for displaying a box identifier for each parcel box in the array.

In an embodiment of the invention, the at least one processor includes a local processor in wired connection with the electrically controlled lock mechanism and the occupancy sensor of each box.

In an embodiment of the invention, the local processor is powered at least in part by at least one electric battery that is charged by at least one solar panel.

In an embodiment of the invention, the communications subsystem includes a cellular or another radio communications module associated with the local processor.

In an embodiment of the invention, the at least one processor includes a regional processor based at a regional parcel processing center.

In an embodiment of the invention, the at least one processor includes a processor of a mobile electronic device of a mailman.

In an embodiment of the invention, the at least one processor includes a cloud-based processing system.

In another aspect, the invention relates to a parcel delivery system for delivering parcels to recipients at a plurality of neighborhood parcel delivery assemblies, which includes: (a) a main processing unit which includes at least a regional processor and an assembly processor; (b) at each neighborhood parcel delivery assembly: (b.1) an assembly processor; (b.2) an array of parcel boxes, each box including: (b.2.1) a front door, the door having an unlocked state, a locked state, a closed state, and an open state; (b.2.2) a controlled door-locking element configured to receive locking and unlocking signals from the assembly processor; (b.2.3) a door opening sensor configured to sense whether the front door is in an open state or in a closed state; (b.2.4) a box occupancy sensor configured to sense whether the box contains a parcel or not; and (b.2.5) the assembly processor, which is in communication with each of the boxes and with a regional processor, being configured to: (i) determine an occupancy status of each box within the array of boxes based on signals received from the occupancy sensors, and report periodically or upon any change to a regional processor; and, (ii) upon receipt of an unlock command activated by a recipient and sent from his mobile phone to unlock a specific box, sending an unlocking signal to the door-locking element of the respective box, thereby to enable the recipient to open the door and collect the parcel from the box.

In an embodiment of the invention, the system includes at a regional parcel processing center: (c) the regional processor, which is at least partially physically located at the regional parcel processing center, the regional processor being configured to: (c.1) communicate with each of the assembly processors at the neighborhood parcel delivery assemblies, receive from each the assembly processors information sufficient to determine the occupancy status of each box within each assembly, and store this occupancy data within a database; (c.2) for each given package, activate a reader to receive an input sufficient to determine from a tag attached to the package: (i) an ID of the package, (ii) a recipient ID, and (iii) a recipient address; and (c.3) based on the recipient address and the occupancy status stored at the database, assign to the given parcel a box at a selected neighborhood parcel delivery assembly.

In an embodiment of the invention, the unlock command is issued by the recipient in response to a notice of parcel arrival which is sent to him from the main processing unit, the issuance being activated only upon arrival of the recipient to the specific assembly ID and specific box ID as indicated within the notice of parcel arrival.

In an embodiment of the invention, the notice of parcel arrival is an SMS message or a message sent by another texting service.

In an embodiment of the invention, the unlock command is activated by the recipient from within the notice of parcel arrival.

In an embodiment of the invention, the system further includes a plurality of recipients' mobile applications, each application operating at a respective recipient mobile phone and being configured to: (a) receive a box unlock permission which is included within the notice of parcel arrival; and (b) send an unlock command to the respective assembly processor in order to unlock the respective box, thereby to enable the recipient to collect the parcel.

In an embodiment of the invention, the recipient application is password protected.

In an embodiment of the invention, the unlock command is sent from the recipient's mobile phone to the assembly processor indirectly through any other processing component of the main processing unit.

In an embodiment of the invention, the system further includes a door locking sensor which is configured to sense whether the front door is in an unlocked state or in a locked state.

In an embodiment of the invention, the system further includes a box circuit within each box, each of the box circuit interfaces between the assembly processor and the sensors and locking elements within the box.

In an embodiment of the invention, the box circuits are serially connected, and the first circuit in the series is connected to the assembly processor.

In an embodiment of the invention, the locking element includes a single bistate solenoid within each box.

In an embodiment of the invention, the boxes are embedded within a wall.

In an embodiment of the invention, the assembly includes one or more front or rear doors, each providing a simultaneous access to a plurality of the assembly compartments.

In an embodiment of the invention, the main processing unit further includes a postman's application which is installed within a mobile device of a postman, the application assists the postman in the delivery of the parcels to their assigned boxes.

In an embodiment of the invention, upon receipt of the parcels from the regional center by the postman, the postman downloads into his mobile phone a “Parcels+Recipients File”, the file details, for each parcel, at least (i) an assigned assembly, (ii) an assigned box within the assembly.

In an embodiment of the invention, any insertion of a parcel into a box is updated either by a barcode scan or manually by the postman within the “Parcels+Recipients File”.

In an embodiment of the invention, any intended insertion of a parcel into a specific box which is based on the “Parcels+Recipients File” transfers the box into an expectation state, in which the box expects to receive the parcel, if however, and based on one or more occupancy sensors, it is determined that a parcel has not been inserted into this specific box, or if it has been determined that a parcel has been inserted into another box, the assembly processor sends to the postman's application an insertion error alert, forcing him to correct the error before continuing to a next parcel insertion.

In an embodiment of the invention, the assembly processor is further configured to send a locking signal to the door-locking element of the respective box, a few seconds after sensing a closure of the front door by said door opening sensor.

In an embodiment of the invention, the assembly processor is further configured to issue a failure box error signal in case of sensing an open front door of the box by said door opening sensor for a duration above a predefined period.

In an embodiment of the invention, the transfer of a box into an expectation state becomes possible only if this box has not been reported as a failure box.

In an embodiment of the invention, the postman's application further includes authorizations for the postman to open doors in the assembly, by use of his mobile device.

In an embodiment of the invention, the “Parcels+Recipients File” further includes (iii) a phone number of the recipient, wherein upon completion of the parcel insertions into their assigned boxes, the postman application sends the notice of parcel arrival to each recipient, respectively.

In an embodiment of the invention, the notice of parcel arrival is sent to the respective recipients from the assembly processor, from the regional processor, or from any other processing component which is associated with the main processing unit.

In an embodiment of the invention, the door of each box is configured to automatically return from an open state to a closed state, unless manually held open by the parcel's recipient.

In an embodiment of the invention, the system further includes at each of the assemblies one or more solar panels and one or more batteries, and wherein each of the assemblies utilizes the solar energy which is accumulated by the solar panels.

In an embodiment of the invention, the assembly processor includes a cellular or radio communication module, for enabling communication with any portion of the main processing unit, and in order to receive via the module the unlock command which is issued by the recipient.

In another aspect, the invention relates to a neighborhood parcel-delivery assembly, which includes: (a) an array of parcel boxes, each box including: (a.1) a front door, the door having a locked state, an unlocked state, a closed state, and an open state; (a.2) a controlled door-locking element configured to receive locking and unlocking signals from an assembly processor; (a.3) a door opening sensor configured to sense whether the front door is in an open or in a closed state; and (a.4) a box occupancy sensor configured to sense whether the box contains a parcel or not; (b) the assembly processor which is in communication with each of the boxes, and with a regional processor, the assembly processor being configured to: (b.1) determine an occupancy status of each box within the array based on signals received from the occupancy sensors, and report periodically or upon any change to the regional processor; and (b.3) upon receipt of an unlock command activated by a recipient and sent from his mobile phone to unlock a specific box, sending an unlocking signal to the door-locking element of the respective box, thereby to enable the recipient to open the door and collect the parcel from the box.

### DETAILED DESCRIPTION OF PREFERRED EMBODIMENTS

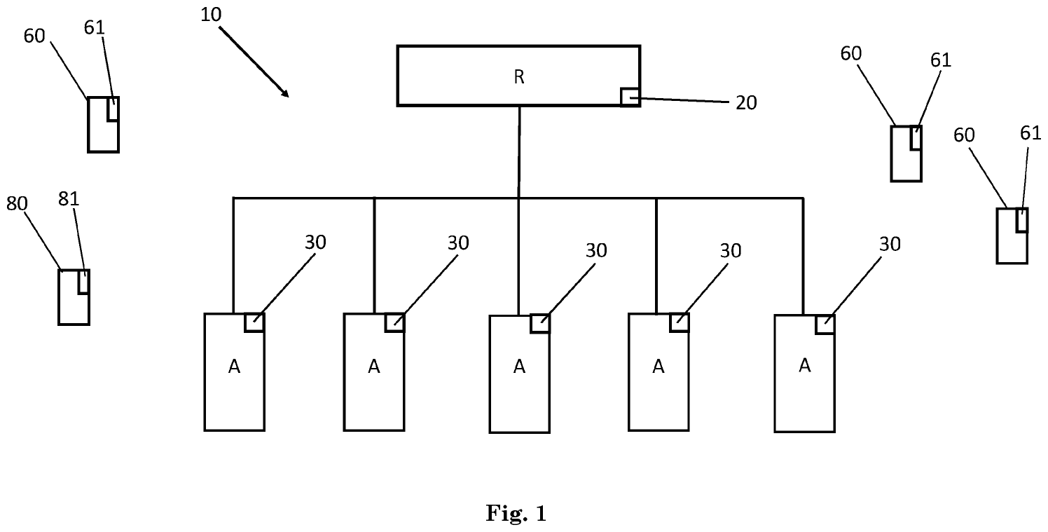

FIG. 1 illustrates in a general block diagram form the structure of the parcel delivery system of the present invention. Throughout this application the term “parcel” relates to a post item which requires a special delivery procedure, different from a standard-enveloped mail, either due to the value of the delivered item, due to its volume, or due to a requirement from the recipient to personally arrive a dedicated location in order to receive the item. The parcel delivery system 10 generally includes a regional delivery center R and a plurality of distributed neighbourhood-type parcel delivery assemblies A (as an example, 5 are shown in the figure). The regional delivery center R includes a regional processor 20 for processing arrival parcels, and each parcel delivery assembly A includes an array of parcel compartments (not shown in this figure) that are controlled by an assembly processor 30. The assembly processors 30 are in communication with the regional processor 20, preferably via wireless Internet lines, for purposes that will be detailed hereinafter. The system further preferably includes a mobile application 61 which is installed within each recipient's mobile phone (or other mobile electronic device) 60, the mobile application communicates, whenever necessary, with one or both of regional processor 20 and assembly processors 30. The system further includes a postman application 81, which is installed within the postman's mobile phone (or other mobile electronic device) 80 and whose function will be elaborated hereinafter. It should be noted that the regional processor 20, the assembly processor 30, and the postman application 81 form a combined, hereinafter “main processing unit”, whose functions are interchangeable. Moreover, some of the functions may be performed from a cloud, for example, so that the geographical location of the various computing units of the system, as described, should not be viewed as limiting.

When occupied, each compartment of the assembly A is designed to contain a single parcel delivery to a single recipient (this “delivery” may sometimes include several simultaneous parcels that are addressed to a same recipient). In contrast to the case of typical rented P.O. boxes, where each box in the array is rented by a specific recipient for a long period, each compartment in the assembly A of the invention is assigned to a recipient for a single delivery only. Upon completion of the single delivery, the empty compartment becomes available for a next parcel delivery, generally to another recipient. As will be described in more details hereinafter, the neighbourhood parcel delivery assembly A of the invention is preferably particularly designed for low power consumption and for simple and low-cost structure, so that it may operate based on independently produced solar power from within the assembly.

It should be noted that the term “neighbourhood-type assembly” does not necessarily limit the invention with respect to its actual positioning. In fact, the assembly may be positioned, or even attached to an external or internal wall of a residential or commercial building or of the regional center's building itself. The assembly may include any number of compartments, from as few as one compartment, to tens, even hundreds of compartments.

Moreover, the fact that the assembly is designed for a low-power operation suitable to be fed from solar plates should not limit the invention. The unit may be connected to the main electricity network as a sole power supply, or as a backup.

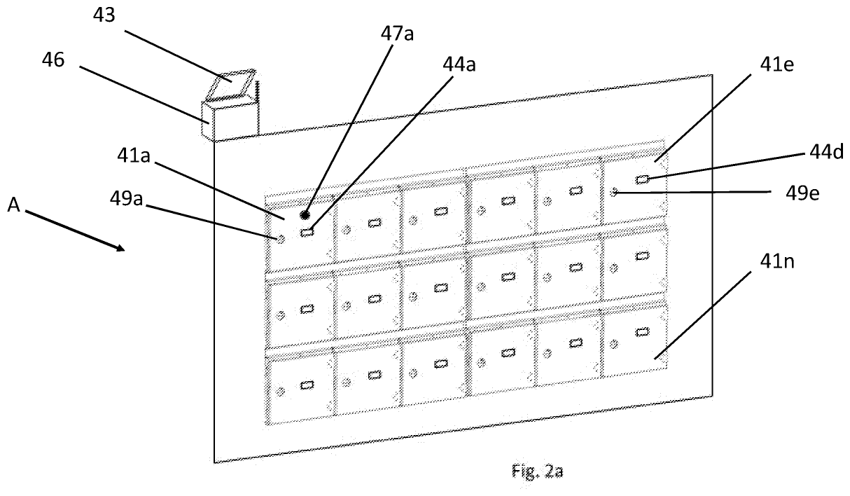

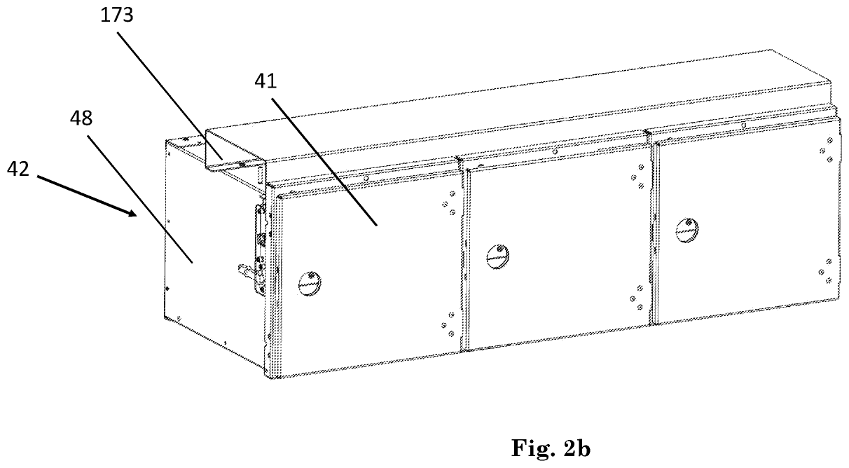

FIG. 2a illustrates in general schematic form an exemplary low-power, neighbourhood-type parcel delivery assembly A, according to an embodiment of the present invention. The assembly includes a plurality of compartments 41a-41n, each being identified by a box ID 44a-44n respectively. Each compartment front door also includes a handle (or the like) 49 for opening the compartment's door. The assembly also includes one or more solar panels 43, that are configured to supply electric power sufficient for the entire operation of the low-power assembly A. The assembly A may also include a common front or rear door (not shown) to enable a simultaneous access by the postman to all the compartments of the assembly, thereby to enable easy and efficient insertion of parcels. Furthermore, the assembly includes a box 46 for the processor 30, for a modem/router which is required for the Internet communication, and for the batteries that may be associated with the solar panels. In some variations, the assembly A may include a door (not shown) to an operational area of the assembly. An operational area is typically useful in an embodiment of the assembly where the compartments have rear openings for a simultaneous access to the compartment by the postman. The inclusion of an operational area, however, is not a requirement, as (a) the postman may insert the parcels via the front doors of the compartments; and (b) one of the compartments or some another available space between or nearby the compartments may be used to contain processor 30, the antenna for the cellular communication, the modem/router, and the batteries, in fact all the components that are included within the schematically shown box 46. The compartments 41 within the assembly A may differ in size, and compartments of various sizes may be included within a same assembly. It should be noted that the configuration of FIG. 2a has been given for illustration only, as many of the conventional assembly structures that are commonly used in the art for parcel delivery may be used for the purpose of the invention, or even may be upgraded to include the features of the present invention. Optionally, a led indicator 47 may also be provided to indicate the status of the compartment door, for example, a red indication means a locked door, while a green indication means an unlocked door.

The compartment identification 44 may be formed either by a conventional sticker, or it may be a small LCD display in which the specific identification is issued by the assembly processor 30 (or the box circuitry).

The assembly A of the present invention is designed to be modular and scalable, such that the size of compartments, as well as their number may be easily changed. FIG. 2b illustrates an exemplary module 42 for a modular assembly A, which includes three box units 41. Each box unit within the assembly is substantially a discrete unit having its own walls, which is inserted, for example, in a drawer-like manner into frame 48. Whenever necessary, a box 41 may be removed, and two or more smaller-size boxes may be inserted within the space of box 41. Alternatively, two (or more) boxes 41 may be removed, for a single large replacement box that will occupy this space. As will become apparent hereinafter, the only complementary action that will be required is a connection of flat cables, and possibly some minor software definitions within processor 30, in order to adapt the system for this modification.

In view of the very significant increase in the number of parcels that are delivered annually, and in order to provide most convenience to the recipients, in some cases the neighbourhood-type assembly A may be relatively small in size, and may include very few, even 1-3 compartments. Such an assembly with 1-3 compartments may be placed, for example, in residential buildings, and may serve all the residents of the building. Such an assembly may be placed within a public area in the building (such as the lobby).

As previously mentioned, the parcel assemblies of the prior art typically employ either a single central display (such as a touch screen), or an individual keypad in each compartment, enabling the recipient to unlock the compartment's door and collect his parcel based on an electronic key which is delivered to him. In contrast, the low-power parcel collection assembly A of the invention preferably requires neither a central display, nor individual keypads in each box. As will be elaborated hereinafter, the recipient activates an “unlock instruction” at a mobile application running within his mobile phone or other mobile electronic device, which is forwarded to processor 30 for opening the specific box.

The processor 30 of each assembly A is typically responsible for some or all of the following functions:
a. It determines and records in its internal memory the occupancy status of each box in the assembly, namely, whether at any given time the box contains an item or not. Moreover, when an item is collected from a box, the processor records that this specific box is no longer occupied. To determine the occupancy status, the processor 30 communicates with a plurality of occupancy sensors (described below), each being mounted within a single box;
b. The processor continuously controls the state of the locking elements of each box, described below. Processor 30 normally keeps the locking elements of the box in their “locked state”. Upon activation by the recipient of an “unlock instruction” (an authorized instruction which also includes a box ID, or otherwise the box ID may be inferred by the processor otherwise”), the processor 30 sends an “unlock command” to the door locking element of the specific box. The unlock instruction may be received either directly—namely by the recipient's application 61 communicating with assembly processor 30 directly, or indirectly, namely, by the recipient's application 61 communicating first with the regional processor 20, which in turn forwards the unlock instruction to processor 30. The unlock instruction may also be sent by the recipient from an SMS message that was sent to him, namely with no use of an application at all.
c. Processor 30 sends occupancy updates, periodically, upon request from the regional processor 20, or upon any change, to the regional processor 20.
d. In one option, and upon insertion of a specific parcel into a box, processor 30 sends to the parcel's recipient a “notice of parcel arrival”, notifying that the parcel is waiting for him in assembly X and box Y (X is the assembly identification, Y is the specific box identification). In other options, the notice of parcel arrival may be sent from the postman's application 81 based on a “Parcels+Recipients File” contained within the postman's mobile phone (more details hereinafter), or from the regional processor 20, based on data which is conveyed to it from the assembly processor 30.
e. During each insertion of a parcel into an assembly box, processor 30, by use of the occupancy sensor of this specific box (and others), also verifies the correction of the parcel insertion into the assigned box. This is done by inspecting where a change in occupancy has occurred following of the insertion, and verifying that this change of occupancy has indeed occurred in the right box, as expected.
f. Processor 30 may communicate with the postman's application 81, for recording postman's visits and details of the parcel distributions to specific boxes. The recorded visits and the specific parcel distribution details (such as in the form: parcel X is now within BoxY-X indicates the parcel ID, Y indicates the box ID) may be reported to the regional processor 20. Otherwise, this data may be added manually or by scanning of the parcel's barcode by the postman, to within the “Parcels+Recipients File”, and then downloaded to the processor 20.
g. Processor 30 may also control the operation of the solar plates 43, in a manner which conventional in the art.

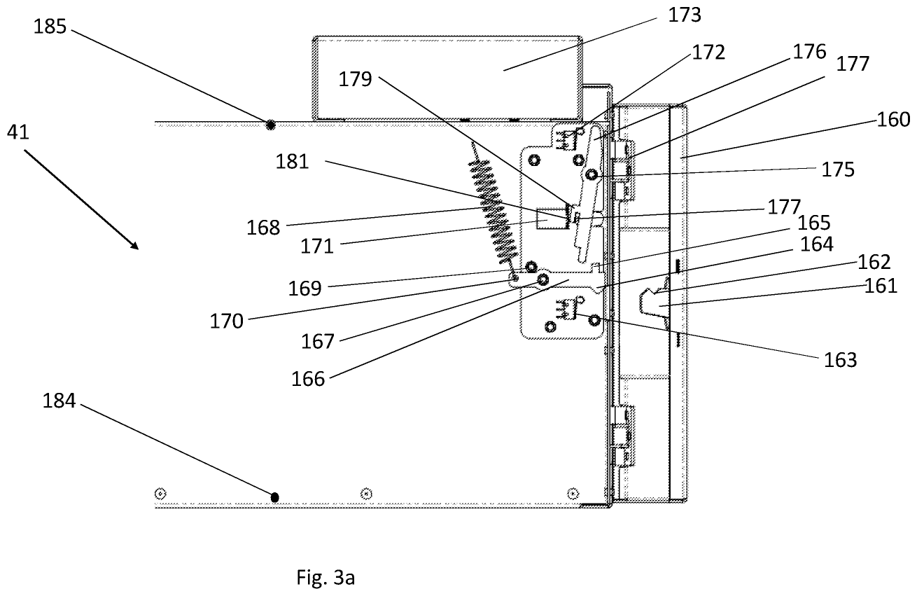

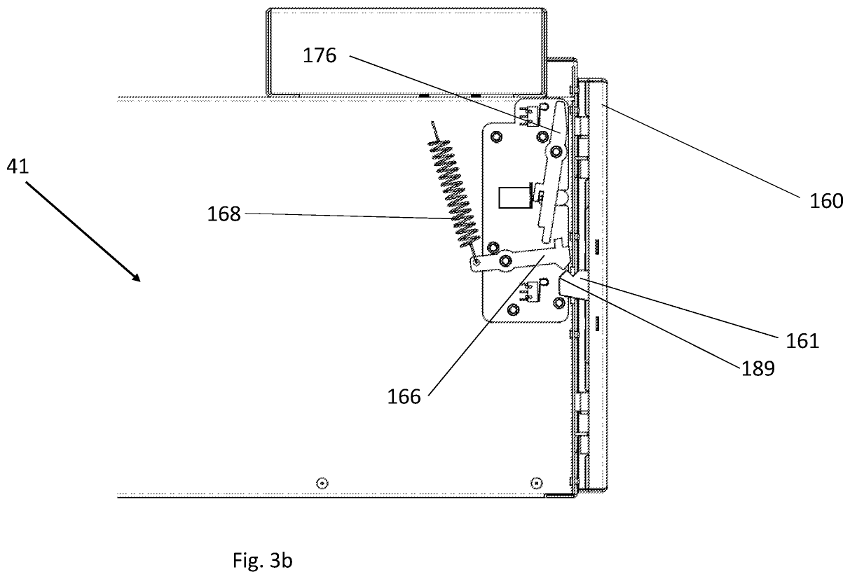

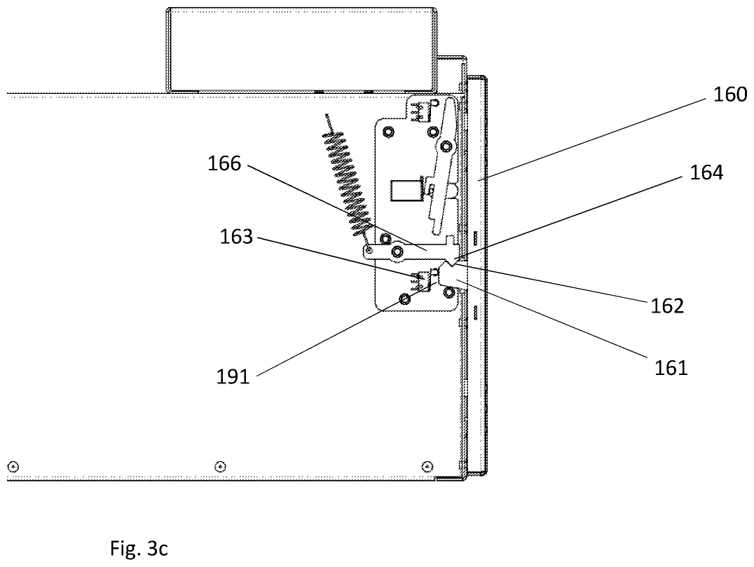

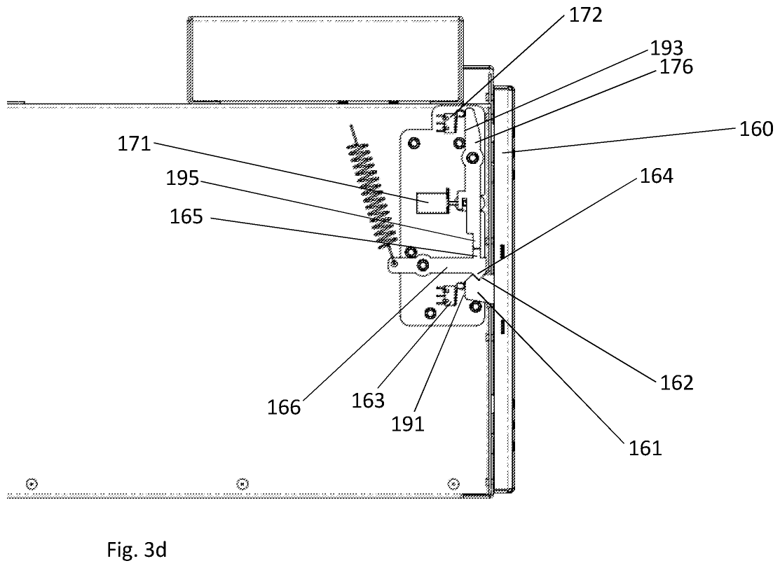

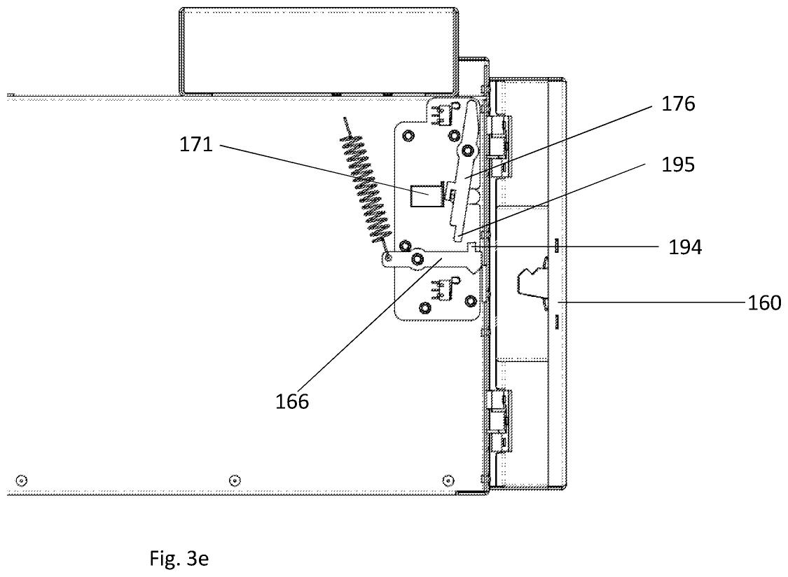

FIGS. 3a-3e generally illustrate a non-limiting example of the internal structure of each compartment 41 of assembly A, according to an embodiment of the invention. The figures particularly illustrate the compartment in several transitional states between a fully opened door state and a fully locked door state. In general the compartment 41 includes a door 160 which is rotatable about hinge element 177, a door guide 161 having a V-shaped recess 162, a door open/close sensor 163, a door locked/unlocked sensor 172, a locking lever 176 which is rotatable about axis 175, a two-state solenoid 171 having a pin 181 which in turn has a protrusion 177 for engagement with a suitable slot 179 in the locking lever 176. The compartment further includes an opening lever 166 which is spring maintained in a stable state by spring 168 and is rotatable about axis 167. The lever also includes at its end a V-shaped protrusion 164 which is compatible with the V-shaped recess 162 at the door guide 161. The compartment also includes a compartment occupancy sensor which in this non-limiting example includes in combination a light emitting diode 184, and a light collecting diode 185. In FIG. 3 the light emitting diode 184 is shown to be at the bottom of the compartment, while the light collecting diode 185 is shown to be at the ceiling of the compartment. This is, however, not a necessity, as a reflective surface may be provided at the ceiling of the compartment, and both of components 184 and 185 may be positioned side by side at the floor of the compartment 41. Other options for occupancy sensor include any and all sensors suitable for differentiating the presence or absence of a parcel within the compartment, including but not limited to, a weight-actuated microswitch, a proximity sensor of any sort, an ultrasound or laser ranging sensor, and a camera with image processing components. The compartment structure further includes a channel 173, for the cables leading from the assembly processor 30 to elements of the various compartments, for example, to a box circuit which is located within each box, and interfaces between processor 30 and the box sensors and solenoid.

FIG. 3a shows the compartment 41 in a fully-open door state. The door 160 is shown open, while the door guide is fully separated from the opening lever 166. In view of the separation of the door guide from the door open/close sensor 163, the sensor in fact provides indication that the door 160 is open. Solenoid 171 pulls, by means of the pin engagement 177, the locked/unlocked lever 176 to its unlocked state. The locking sensor 172 indicates a door unlock state, in view of the separation between the lever 176 and the sensor 172.

FIG. 3b shows a transitional state towards the closure of door 160. In this transitional state, the slope 189 of the door guide 161 pushes the opening lever 166 upwards against the spring. This upwards movement is possible in view of the unlock state of the locking lever 176.

FIG. 3c shows the compartment in a transitional closed state, but still unlocked. Door 160 is closed, therefore the V-shaped protrusion 164 of the opening lever 166 seats within the compatible V-shaped recess 162 at the door guide 161. Furthermore, the engagement of the external surface 191 of the door-guide 161 with the door opened/closed sensor 163 provides a “closed” indication.

FIG. 3d shows the compartment in a fully closed and locked state. As in the transitional closed state of FIG. 3c, the door 160 is closed, therefore the V-shaped protrusion 164 of the opening lever 166 seats within the compatible V-shaped recess 162 at the door guide 161. Furthermore, the engagement of the external surface 191 of the door-guide 161 with the door open/close sensor 163 causes a “closed” indication by sensor 163. Solenoid 171 pushes the lever 176 into its “locked” state, therefore the locking sensor 172, by its engagement with the external surface 193 of the locking lever 176 indicates a door “locked” state. Furthermore, the tight engagement between the protrusion 195 of the locking lever 176 with the protrusion 165 from the opening lever 166 prevents any possible upwards movement of lever 166, therefore any possibility for the V-shaped protrusion 164 at the opening lever 166 to disengage from the door guide 161.

FIG. 3e shows the compartment in a transitional unlocked state, towards opening of the door 160. To enable opening, the solenoid 171 pulls the locking lever 176, which thereby releases the locking lever's protrusion 195 from its tight engagement with the protrusion 194 of the opening lever 166, thereby enabling lever 166 to go upwards and to enable opening. Therefore, the pulling of the door 160 towards its fully open state becomes possible, as shown in this figure.

It should be noted that the door of the compartment of the invention includes still an additional spring (or another equivalent component) that pulls the door to a closed-door state unless the door is held open by the recipient. This configuration secures the closure of the compartment independently from the recipient, immediately when the recipient releases the door after collection of the parcel. Processor 30, which senses the door closure by means of the opening door sensor 161, locks the door a few seconds thereafter. If however, a door is found to be in an open state an unreasonable duration (for example, more than 2 minutes), processor 30 may not activate the locking of the door, and will instead issue an error signal that will be sent to the regional processor 20, and/or to a postman's application 81, depending on the situation. Preferably, at any given time processor 30 unlocks at most one compartment door 41. This feature contributes to the privacy of the recipient, and also to the safety of the entire system, as it prevents a simultaneous parcel robbery from a plurality of the assembly's boxes.

As described, the entire mechanism of the invention which enables closure, locking, and opening of the door includes only a single bi-state solenoid. The rest of the door components are passive in terms of power consumption. Therefore, the closure, locking, and opening mechanism of the invention is very efficient in terms of power consumption.

Although the exemplary locking mechanism described herein is believed to be particularly advantageous, it should be noted that a wide range of variant and alternative mechanisms also fall within the scope of the present invention. Most preferably, the actuator mechanism is chosen to require power only during its change of state, for locked to unlocked, and from unlocked to locked, while being stable without consuming power in each state (i.e., bistable). A wide selection of linear or rotary electromechanical actuators or motors may be used to provide such functionality. Although less preferred, a one-way actuator acting to unlock against a spring bias which returns the lock to a locked state once power to the actuator is interrupted also falls within the broad scope of the present invention. Similarly, although described here with microswitches to detect closure of the door and locking of the lock mechanism, one or both of these sensors may be replaced by any other suitable sensor, including but not limited to, various optical sensors and any other type of contact switch. The geometry and direction of motion of components of the locking mechanism can also vary considerably, as will be clear to a person having ordinary skill in the art.

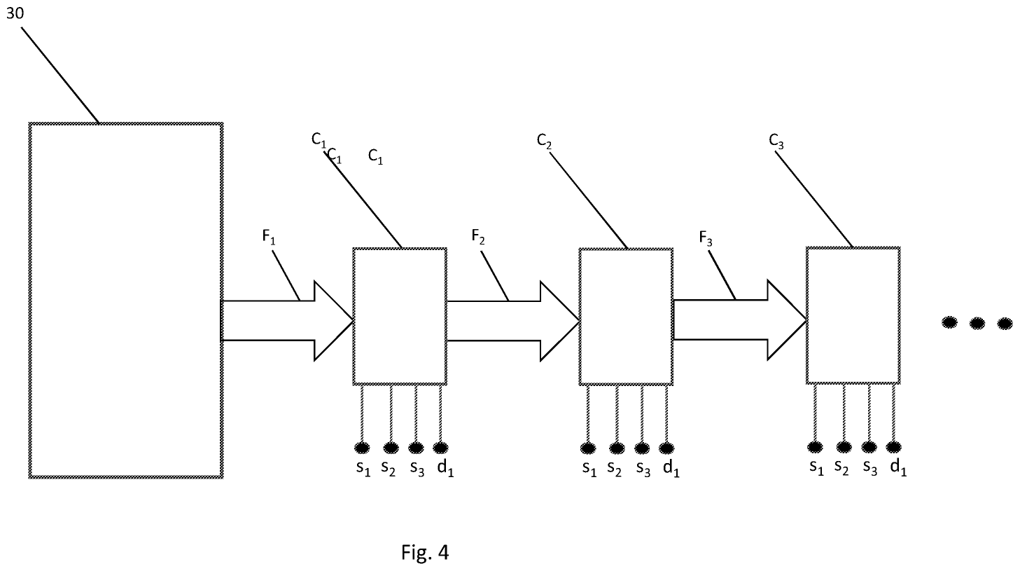

FIG. 4 describes in a block diagram form how the assembly processor 30 controls and monitors the operation of each compartment, according to an embodiment of the invention. An electronic circuit, C₁, C₂, C₃, C₄, . . . etc., is provided in each of the compartments 41a, 41b, 41c, 41d, . . . respectively. The circuits are typically connected in series by means of flat cables F₁, F₂, F₃, . . . , respectively, for example, an 8-wire flat cable each. Each circuit monitors the status of the sensors within the relevant box by respective wires or wire pairs, namely, it is connected to S₁=the locking sensor (172 in FIG. 3), to S₂=the opening sensor (173 in FIG. 3), and to S₃=the occupancy sensor (184-185 in FIG. 3). Furthermore, the circuit provides the control signals to d₁=the locking/unlocking solenoid (171 in FIG. 3). In some cases, the circuit may also include a driver for the solenoid signals. Each circuit C has its own circuit serial bus ID, such that the processor can distinguish between the circuits, and their inputs/outputs. Moreover, the processor supplies the DC voltage to each of the circuits via the flat cables. In any case, the fact that only a single bi-state solenoid is used within each compartment, for which a supply of signal is required only when a change of state is desired, significantly minimizes the consumption of power. Furthermore, the power consumption by the circuits during “sleep” times and during sampling times from the sensors is minimal, enabling the assembly to operate independently by the solar energy which is provided by the solar panels 43, that charge one or more batteries which continue to power the system at night and during other low-light conditions. Optionally, electrical energy from the main electricity network (if such is available) may be supplied to charge the batteries, as a complementary energy.

The system of the present invention allows a simultaneous retrieval of parcels from the boxes by plurality of recipients. The fact that in the box circuits of the invention are serially connected (in the exemplary embodiment of the invention), does not prohibit such a simultaneous retrieval.

### Example 1

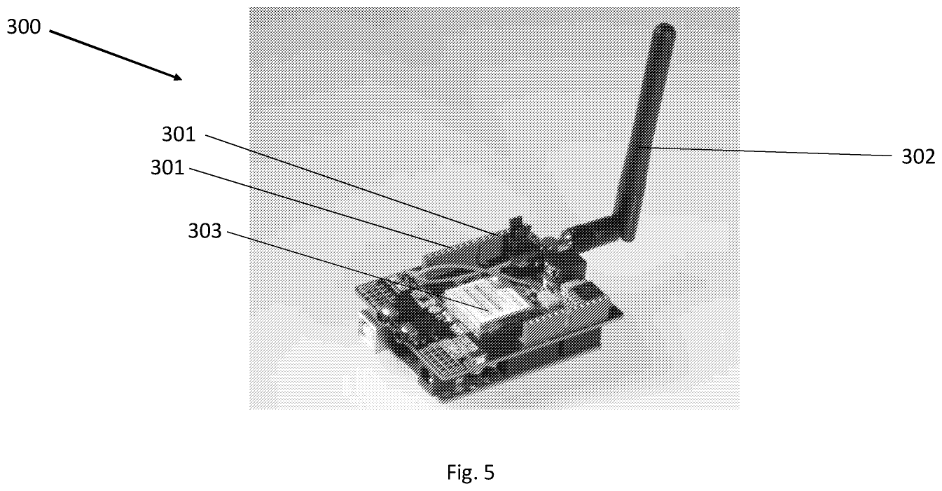

An exemplary circuit 300 for processor 30 is shown in FIG. 5. The exemplary circuit includes:
a. A CPU 303, 32_{BIT}, 16 MHz and up;
b. Plugs 301 for the flat cables leading to the control circuits at the compartments;
c. Antenna 302 for the cellular communication;
d. 8 K SRAM memory;
e. 4K EEPROM memory;
f. An onboard cellular modem, or an external one.

The following is an exemplary configuration for each of the 8-wire flat cables that lead DC voltage and signals between processor 30 and each of the compartment's circuits (several of them in both directions):
1. 12V DC;
2. CLK—Clock for timing and synchronization;
3. I/O—Read/Write mode of operation: either “read”—namely reading from the sensors, or “write”—namely sending a “lock” or “unlock” command to the solenoid;
4. P/S—Serial/Parallel mode of operation: either a “serial” mode during which data is transferred in the serial channel from the compartment's circuits to the processor 30, or a “parallel” mode during which the compartment circuits operate independently;
5. Ser. —a line for a serial transfer of data between the processor 30 and the compartment circuits (in both directions);
6. Reset—A signal for resetting the compartment's circuits;
7. Spare;
8. DND—Ground.

As noted hereinabove, the invention preferably includes two dedicated mobile applications, one for the postman who delivers the parcels to the assemblies, and puts them in their assigned compartments, and another mobile application for the recipients. The term “mobile application” is used herein broadly to refer to the desired functionality as detailed below operating on a personal mobile electronic device, whether provided as a locally-installed “APP” on a mobile phone or the like, as a browser-based application running directly from a remote server or the “cloud”, or implemented using dedicated hardware or any other combination of hardware, firmware and software implemented in a dedicated mobile device (the latter option being particularly relevant for the postman mobile device). Typically, the following modules are provided in the recipient application and may optionally also be present in the postman application:
a. An interface for handling authorizations: definition or a change of username, password, and username details;
b. A screen display designated for the door opening, which enables the user to: (i) type a password; (ii) insert parcel ID and box ID;
c. A screen display for possibly assigning an authorization to another person to collect a parcel (or open a specific box door). Depending upon the applicable legal requirements for authentication to receive a given parcel, this authorization may not require any additional procedure, such as a face to face meeting between the recipient and the person who receives the power.

In addition, the postman's application typically includes one or more of the following modules:
a. A module for processing (e.g., scanning barcodes or otherwise identifying) parcels received by the postman at the post office;
b. A module for processing parcels at the neighbourhood assembly;
c. An optional module for sending SMS (or equivalent) messages to the recipients;
and
d. An optional module for performing maintenance of the assembly; and
e. An optional module for downloading updated parcel data back to the regional processor 20.

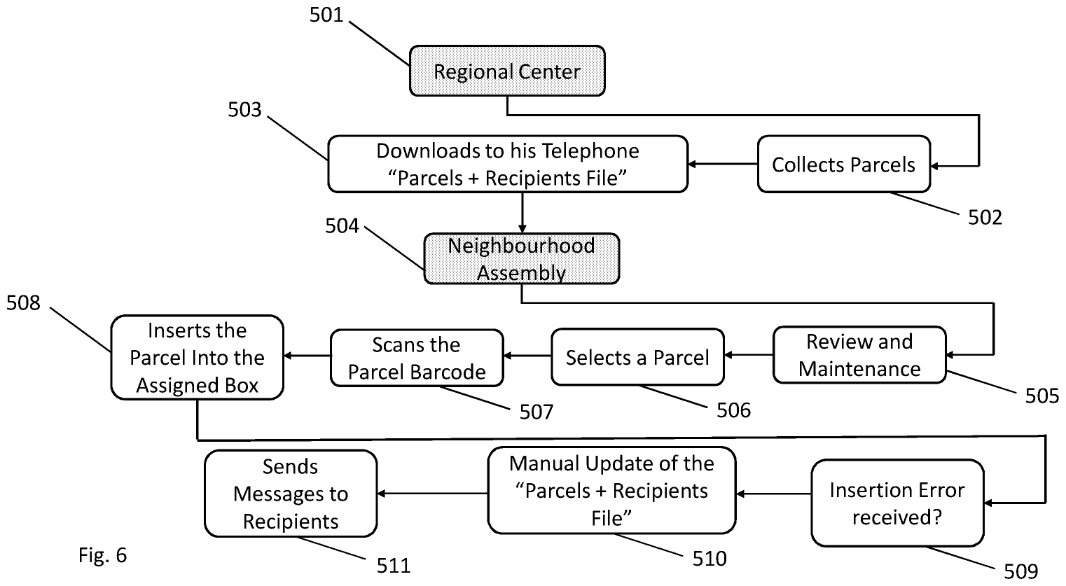

FIG. 6 describes a procedure which is preferably performed by the postman. In step 501 the postman arrives the regional center, and in step 502 the postman collects all the parcels that have to be delivered and loads them into his car. In step 503 the postman downloads into his mobile phone a “Parcels+Recipients File” which contains a list of all the parcels that have to be delivered, and for each parcel, the following details: (a) an assembly ID (preferably in barcode format); (b) a box ID; (c) the recipient mobile phone; and (d) a Y/N parcel status, namely whether the parcel has been inserted into the box or not yet. Of course, initially, and upon receipt of the parcels at the regional center, the status for all the parcels are “NO”. This status will be updated later. Next, in step 504 the postman drives to the first neighbourhood assembly A. Upon arrival, the postman may perform in step 505 a visual inspection of the assembly, or possibly he may also a perform a computerized maintenance procedure, by connecting his mobile application to the processor 30 of the assembly. The maintenance procedure may be performed by a dedicated module within the postman's application. In step 506 the postman selects a first parcel for delivery, scans (step 507) by use of his mobile phone the parcel's barcode and determines from his application the box ID which is assigned for this specific parcel. Based on the box ID which is assigned for that parcel, the door may automatically be unlocked for insertion of the parcel by the postman, or he may himself open the door of the compartment (or a common rear or front door, if exists). By scanning the parcel's barcode, in step 508 one corresponding box which is assigned (based on the details of the “Parcels+Recipients File”) to receive this specific parcel is activated, such that it is “waiting” to receive the parcel. The postman continues by opening the assigned compartment (if it is not a common rear or front door), and inserting the parcel into the compartment, and closing the door (assuming that it was not a common door). The door will be automatically locked either immediately in response to sensing of the closing of the door or a few seconds later by the processor 30 sending a suitable “lock” command to the specific compartment's circuit, as described above. It should be noted that depending on the structure of the assembly: (a) If the compartments in the assembly have a front door only (which is not a common door), the postman opens the front door based on an authorization given to him together with the “Parcels+Recipients File” that was downloaded into his mobile phone; or (b) Alternatively, if the compartments of the assembly have also rear apertures for the insertion of the parcels by postmen via the operational area (or a common door), the postman instead uses his authorization to reach the operational area and he inserts the parcel via the rear aperture instead. Moreover, upon scanning of the parcel's barcode in step 507, the application updates the status of the specific parcel within the “Parcels+Recipients File” to “YES”, namely that the parcel has been inserted into the box. Based on the assigned box, in step 509 processor 30 uses the occupancy sensor (184-185 in FIGS. 3a-3e) to verify that a change of occupancy has indeed occurred within the assigned and activated compartment. As noted, only one parcel and its assigned compartment are activated in any given time, therefore a change of occupancy is expected only in this specific compartment. If an occupancy change in that assigned compartment has not been detected, and/or if a change has been detected in an adjacent compartment, such a situation means that the parcel was inserted into a wrong compartment. Processor 30, upon such a determination, will immediately issue an error (or error signal), that will be sent to the postman's application 81, instructing him to correct the error. If an error has been detected in step 509, the postman will not be able to continue with a next parcel, unless he has corrected the error. It should be noted that a similar error detection procedure operates also during retrieval of parcels by the postman from specific boxes, in case that a parcel has not been retrieved from a box by a recipient within a predefined time.

Furthermore, if, a specific parcel does not have a barcode (and therefore the scanning step 507 cannot be performed), in optional step 510 the postman updates manually that the specific parcel was inserted into the assigned box. Steps 506-510 are repeated by the postman until the postman completes the insertion of all the parcels into their assigned boxes in this specific assembly A.

Upon completion, and based the details that are listed in the “Parcels+Recipients File”, in step 511 the mobile application of the postman sends via the postman's mobile phone respective SMS messages to the mobile phones of all the relevant recipients. The message to a recipient may have, for example, the following form: “Dear customer: A parcel having a parcel ID 7346872 is waiting for you in Box 94 in a neighbourhood parcel collection assembly which is located at 107, 14th street NY, N.Y. Upon arrival to the assembly, and in order to open the box, please type the following code within your application: 657849. The door of the box will be unlocked for you for a duration of 20 seconds to enable you to collect your parcel, and then will be relocked. Please take care not to activate this code unless you are in the proximity of the above-indicated assembly and parcel compartment”. Alternatively, the SMS messages (or any other short texting messages) of step 511 may be sent via remote SMS server, which is networked with the mobile phone of the postman.

Following the sending of the SMS messages, the “Parcels+Recipients File” is updated respectively that the messages were sent, and the sending date and time of the messages is also recorded. Alternatively, the messages may be sent from any other computerized unit which is a part or is associated with the main processing unit.

As shown, the fact that the SMS messages are sent directly from the mobile phone of the postman is advantageous, as the messages are in fact sent to the recipients automatically and essentially immediately after the insertion of the packages into their assigned compartments. Alternatively, and as said, the messages may be sent to the recipients from the assembly computer 30, from the regional computer 20, or from any other system which is capable of sending SMS messages, however the latter procedure requires an additional communication between the postman's application and the relevant computer in order to share relevant data which is necessary for the issuance of the messages.

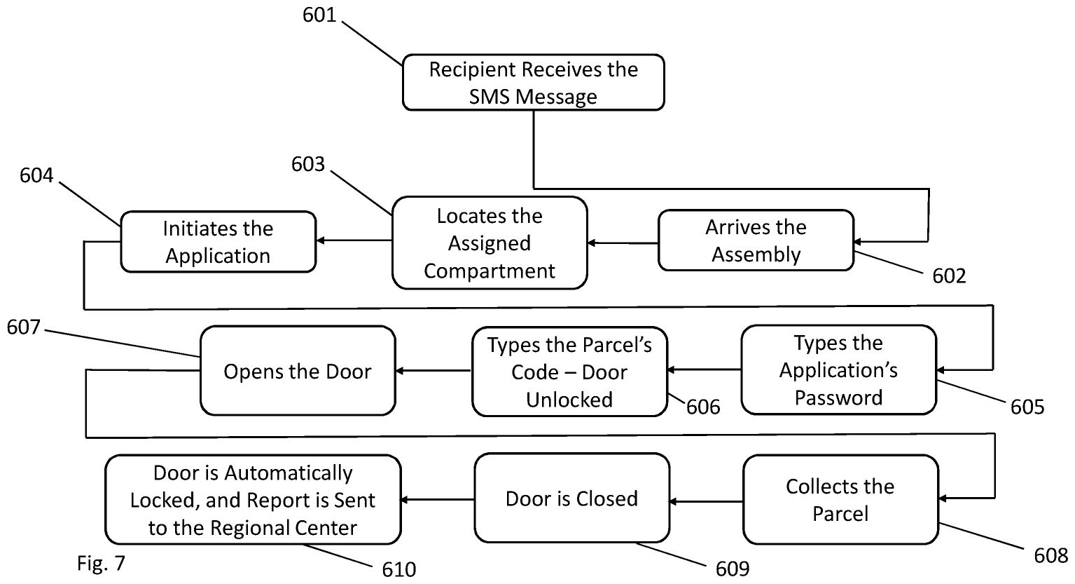

FIG. 7 is a block diagram illustrating the procedure which is carried out by the recipient in order to collect his item. In step 601 the recipient receives into his mobile phone the SMS message, having the form as described above. Based on the details that were included in the message, in step 602 the recipient arrives to the assigned assembly, and in step 603 he locates the specific compartment as also indicated within the message. He then initiates the mobile application (step 604), and in step 605 he types his password to the application. In step 606, the recipient types the parcel collection code that was included within the application. The application then initiates communication with computer 30, which in turn unlocks the compartment's door. The recipient then opens the door (step 607), and collects the parcel (step 608). After the collection of the parcel, the recipient leaves the door, which is automatically closed by means of the door's spring (step 609). A few seconds later (typically about 10-20 seconds), computer 30 locks the door (step 610). Computer 30 also reports to the regional center that the specific parcel was collected, and processor 30 forwards this update to the regional processor 20. It should be noted again that the use of the recipient's application in order to unlock the door is optional, although preferable. In another embodiment, the recipient may issue the unlock command directly from the SMS message which was sent to him.

In one embodiment of the invention, and upon arrival of the parcel into the regional center, the regional center sends a notification SMS to the parcel's recipient giving the recipient an opportunity to select, within a limited period, a neighbourhood assembly which is most convenient to him. If the recipient indeed utilizes this option, the regional center sends the parcel to the assembly, as selected by the recipient.

As described the invention provides a procedure which enables a recipient to conveniently collect his parcel 24 hours a day, 365 days a year. The regional center receives an update from the processor 30 of the assembly essentially immediately upon the parcel's collection. This information is registered at the regional center, so the regional center knows that the compartment has become available for a next parcel delivery. If, however, the regional center notices that a parcel was not collected within a reasonable time, the regional center may send one or more SMS reminders to the recipient, giving him an additional time for the collection of the parcel. If, however, the recipient does not come to collect the parcel even within the additional period, this parcel is assigned for the collection by the postman in the “Parcels+Recipients File”. The postman collects the parcel in a similar manner to the procedure of FIG. 6, and returns the parcel to the regional center, which typically returns the parcel to the sender.

### Example 2

The estimated power that each compartment's circuit continuously consumes is negligible. The highest consumer of current in the system is the single solenoid existing in each compartment. This consumption is, however, temporary, and occurs only during times of solenoid transitions from lock to unlock states and vice versa. During each of such transfer of state the solenoid consumes about 6 W (12V, 0.5 A). Assuming that 60 openings occur per day in an assembly (1 minute each), it is estimated that the power will not exceed 1 A-h per day. The power consumption of the cellular communication from processor 30 is comparable to the power consumption of a smartphone in which the touch screen is never activated, while the smartphone operates with communication of SMS only. This power consumption of processor 30 is therefore estimated to be about 1 A-h. Therefore, the total power consumption in an assembly according to the present invention is estimated to be about 7 A-h per day.

As shown, the present invention provides a parcel delivery system, a parcel delivery assembly, a parcel delivery box structure, that are very convenient and efficient to the recipient, to the postman, and to the delivery organization. The parcel delivery assembly is also very efficient in terms of power consumption, so it may operate solely based on solar energy.

While the invention has been described with respect to a limited number of embodiments, it will be appreciated that many variations, modifications and other applications of the invention may be made. Therefore, the claimed invention as recited in the claims that follow is not limited to the embodiments described herein.

1. A parcel delivery system for allowing recipients to retrieve parcels by use of a mobile electronic device of the recipient, the system comprising:
a processing system comprising at least one processor and a communications subsystem;
an array of parcel boxes, each parcel box comprising:
an enclosure having a front opening;
a door displaceable between a closed state, obstructing said front opening, and an open state, allowing access via said front opening to said enclosure;
an electrically controlled lock mechanism configured to be switchable in response to a signal from said processing system from a locked state in which said lock mechanism prevents displacement of said door from said closed state to said open state to an unlocked state in which a recipient can displace said door from said closed state to said open state;
an enclosure occupancy sensor in communication with said processing system and configured to sense whether or not said enclosure contains a parcel:
wherein said processing system is configured, for each parcel to be delivered, to:
allocate to the parcel one of said boxes determined to be empty based on an output of said occupancy sensor;
determine when the parcel has been placed in the allocated box based at least in part on the output of said occupancy sensor,
send to the mobile electronic device of the recipient a notification indicative of the allocated box; and
on receipt of an unlock request received from the mobile electronic device of the recipient, to actuate said lock mechanism to switch from said locked state to said unlocked state, thereby allowing opening of said door by the recipient to retrieve the parcel without a central display or keypad associated with the array of parcel boxes,
thereby allowing simultaneous retrieval of parcels from the boxes by a plurality of the recipients,
wherein said processing system includes a remote processing system located remotely from the array of parcel boxes and a low-power local processor in wired connection with said electrically controlled lock mechanisms and said enclosure occupancy sensors, said remote processing system and said local processor being in communication via a mobile network, wherein authorization of the unlock request is performed by a wireless application running on the wireless electronic device of the recipient and/or by the remote processing system, which generate an unlock instruction sent to said low-power local processor to unlock the corresponding electrically controlled lock mechanism.

2. The parcel delivery system of claim 1, further comprising a door opening sensor in communication with said processing system and deployed to sense whether said door is in said open state or in said closed state.

3. The parcel delivery system of claim 2, wherein said electrically controlled lock mechanism comprises a bistable actuator, and wherein said processing system is further configured to be responsive to closing of said door as sensed by said door opening sensor to actuate said lock mechanism to switch from said unlocked state to said locked state.

4. The parcel delivery system of claim 3, wherein said processing system is further configured to be responsive to said occupancy sensor indicating that the parcel has been removed from the allocated box to designate the allocated box as an available box for allocation to a subsequent parcel.

5. The parcel delivery system of claim 2, further comprising a door biasing arrangement biasing said door to return from said open state to said closed state.

6. The parcel delivery system of claim 2, wherein said processing system is further configured to periodically retrieve an output from said occupancy sensor of each box and to compare a detected occupancy output with an expected occupancy output, said processing system generating an error signal if said detected occupancy output does not match said expected occupancy output.

7. The parcel delivery system of claim 6, wherein said processing system is configured to receive from a mobile electronic device of a mailman an indication of a parcel scanned prior to loading into an allocated box, said indication being used to update an expected occupancy setting for said allocated box.

8. The parcel delivery system of claim 2, wherein each parcel box further comprises a lock status sensor associated with said processing system and configured to generate a signal indicative of whether said electrically controlled lock mechanism is in said locked state or said unlocked state.

9. The parcel delivery system of claim 8, wherein said processing system is responsive to signals from said lock status sensor and said door opening sensor to generate an error signal if said door remains in a state other than closed and locked for more than a defined period.

10. The parcel delivery system of claim 1, wherein said array of parcel boxes comprises a plurality of parcel boxes, and wherein said enclosure of each of said parcel boxes comprises at least four walls such that removal and replacement of one of said parcel boxes does not compromise the enclosure of neighboring parcel boxes.

11. The parcel delivery system of claim 10, wherein each of said parcel boxes carries a reconfigurable display for displaying a box identifier for each parcel box in said array.

12. (canceled)

13. The parcel delivery system of claim 1, wherein said local processor is powered at least in part by at least one electric battery that is charged by at least one solar panel.

14. (canceled)

15. The parcel delivery system of claim 1, wherein said remote processing system includes a regional processor based at a regional parcel processing center.

16. The parcel delivery system of claim 1, wherein said remote processing system includes a processor of a mobile electronic device of a mailman.

17. The parcel delivery system of claim 1, wherein said remote processing system includes a cloud-based processing system.

18. A parcel delivery system for delivering parcels to recipients at a plurality of neighborhood parcel delivery assemblies, which comprises:
a main processing unit which comprises at least a regional processor and an assembly processor;
at each neighborhood parcel delivery assembly:
an assembly processor;
an array of parcel boxes, each box comprising:
a front door, said door having an unlocked state, a locked state, a closed state, and an open state;
a controlled door-locking element configured to receive locking and unlocking signals from said assembly processor,
a door opening sensor configured to sense whether said front door is in an open state or in a closed state;
a box occupancy sensor configured to sense whether the box contains a parcel or not; and
said assembly processor, which is a low-power local processor in wired communication with said sensors and locking element within each of said boxes, and is in communication with the regional processor via a wireless network, being configured to:
determine an occupancy status of each box within said array of boxes based on signals received from said occupancy sensors, and report periodically or upon any change to a regional processor,
and
upon receipt of an unlock instruction, to unlock a specific box, sending an unlocking signal to the door-locking element of the respective box, thereby to enable the recipient to open the door and collect the parcel from the box without a central display or keypad associated with the array of parcel boxes,
thereby allowing simultaneous retrieval of parcels from the boxes by a plurality of the recipients,
wherein authorization of an unlock request from a recipient is performed by a mobile application running on a mobile electronic device of the recipient and/or by the regional processor, which generate the unlock instruction sent to said assembly processor to unlock the corresponding electrically controlled lock mechanism.

19. A parcel delivery system according to claim 18, further comprising, at a regional parcel processing center:
said regional processor, which is at least partially physically located at the regional parcel processing center, said regional processor being configured to:
communicate with each of said assembly processors at the neighborhood parcel delivery assemblies, receive from each said assembly processors information sufficient to determine the occupancy status of each box within each assembly, and store this occupancy data within a database;
for each given package, activate a reader to receive an input sufficient to determine from a tag attached to the package: (i) an ID of the package, (ii) a recipient ID, and (iii) a recipient address; and
based on said recipient address and said occupancy status stored at the database, assign to the given parcel a box at a selected neighborhood parcel delivery assembly.

20. A parcel delivery system according to claim 18, wherein said unlock request is issued by the recipient in response to a notice of parcel arrival which is sent to him from said main processing unit, said issuance being activated only upon arrival of the recipient to the specific assembly ID and specific box ID as indicated within said notice of parcel arrival.

21. A parcel delivery system according to claim 18, wherein said notice of parcel arrival is an SMS message or a message sent by another texting service.

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. A neighborhood parcel-delivery assembly, which comprises:
an array of parcel boxes, each box comprising:
a front door, said door having a locked state, an unlocked state, a closed state, and an open state;
a controlled door-locking element configured to receive locking and unlocking signals from an assembly processor:
a door opening sensor configured to sense whether said front door is in an open or in a closed state; and
a box occupancy sensor configured to sense whether the box contains a parcel or not;
said assembly processor, which is a low-power local processor in wired communication with said sensors and locking element within each of said boxes, and is in communication with a regional processor via a wireless network, being configured to:
determine an occupancy status of each box within said array based on signals received from said occupancy sensors, and report periodically or upon any change to said regional processor,
and
upon receipt of an unlock instruction to unlock a specific box, sending an unlocking signal to the door-locking element of the respective box, thereby to enable the recipient to open the door and collect the parcel from the box without a central display or keypad associated with the array of parcel boxes,
thereby allowing simultaneous retrieval of parcels from the boxes by a plurality of the recipients,
wherein authorization of an unlock request from a recipient is performed by a mobile application running on a mobile electronic device of the recipient and/or by the regional processor, which generate the unlock instruction sent to said assembly processor to unlock the corresponding electrically controlled lock mechanism.
